(19) United States
(12) Patent Application Publication
(10) Pub. No.: US 2023/0103109 A1
(43) Pub. Date: Mar. 30, 2023

(54) PARKING LOT MANAGEMENT SYSTEM, PARKING LOT MANAGEMENT METHOD, AND STORAGE MEDIUM

(71) Applicant: TOYOTA JIDOSHA KABUSHIKI KAISHA, Toyota-shi (JP)

(72) Inventors: Takanori IMAZU, Susono-shi (JP); Yoshiki Fukada, Susono-shi (JP); Ryuji Okamura, Gotemba-shi (JP); Takashi Hayashi, Mishima-shi (JP); Kohki Baba, Susono-shi (JP); Satoshi Omi, Ebina-shi (JP); Akihiro Kusumoto, Susono-shi (JP); Yuta Kataoka, Tokyo (JP)

(73) Assignee: TOYOTA JIDOSHA KABUSHIKI KAISHA, Toyota-shi (JP)

(21) Appl. No.: 17/885,935

(22) Filed: Aug. 11, 2022

(30) Foreign Application Priority Data
Sep. 27, 2021 (JP) 2021-156719

(51) Int. Cl. G08G 1/14; G06Q 10/02; B60W 30/06

(52) U.S. Cl. CPC G08G 1/148; G08G 1/141; G08G 1/146; G08G 1/149; G06Q 10/02; B60W 30/06

(57) ABSTRACT

A parking lot management system for managing a parking lot intended for autonomous vehicles and manually driven vehicles includes: a reservation unit configured to reserve a parking space for an autonomous vehicle; and a reserved parking space notification unit configured to notify a manually driven vehicle in the parking lot of the reserved parking space.

### CROSS-REFERENCE TO RELATED APPLICATION

This application claims priority to Japanese Patent Application No. 2021-156719 filed on Sep. 27, 2021, incorporated herein by reference in its entirety.

### BACKGROUND

### 1. Technical Field

The present disclosure relates to a parking lot management system, a parking lot management method, and a storage medium.

### 2. Description of Related Art

In a known automatic parking system for autonomous vehicles, when another autonomous vehicle is already parked in a parking space where an incoming autonomous vehicle is going to be parked, the parking priority of the incoming autonomous vehicle is compared with the parking priority of the autonomous vehicle already parked in the parking space, and when the parking priority of the incoming autonomous vehicle is higher than the parking priority of the autonomous vehicle already parked in the parking space, the autonomous vehicle already parked in the parking space is moved to another parking space by autonomous driving in order to park the incoming autonomous vehicle in the parking space (see, e.g., Japanese Unexamined Patent Application Publication No. 2020-77064 (JP 2020-77064 A)).

### SUMMARY

However, when a parking lot is intended for both autonomous vehicles and manually driven vehicles, a manually driven vehicle may be already parked in the parking space where an autonomous vehicle is going to be parked. In this case, it is actually difficult to get this manually driven vehicle moved to another parking space in order to park this autonomous vehicle in the parking space.

In order to solve the above problem, according to the present disclosure, a parking lot management system for managing a parking lot intended for autonomous vehicles and manually driven vehicles is provided. The parking lot management system includes: a reservation unit configured to reserve a parking space for an autonomous vehicle; and a reserved parking space notification unit configured to notify a manually driven vehicle in the parking lot of the reserved parking space.

According to the present disclosure, a parking lot management method for managing a parking lot intended for autonomous vehicles and manually driven vehicles is also provided. The parking lot management method includes: reserving a parking space for an autonomous vehicle; and notifying a manually driven vehicle in the parking lot of the reserved parking space.

According to the present disclosure, a non-transitory storage medium storing a program for managing a parking lot intended for autonomous vehicle and manually driven vehicles is also provided. The program causes a computer to perform functions including: reserving a parking space for an autonomous vehicle; and notifying a manually driven vehicle in the parking lot of the reserved parking space.

A parking space can thus be secured for an autonomous vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view illustrating an example of an automatic parking lot;

FIG. 2 is a side view of the automatic parking lot shown in FIG. 1;

FIG. 3 illustrates a pickup and drop-off management server;

FIG. 4 illustrates an autonomous vehicle;

FIG. 5 is a flowchart of pickup and drop-off management control;

FIG. 6 is a flowchart of vehicle driving control;

FIGS. 7A and 7B are enlarged views of a part of the parking lot shown in FIG. 1;

FIG. 8 is an enlarged view of a part of the parking lot shown in FIG. 1;

FIG. 9 shows a drop-off reservation process for the parking lot;

FIG. 10 is a flowchart of a parking space reservation notification process;

FIG. 11 shows a drop-off reservation process for the parking lot; and

FIG. 12 is a flowchart of a parking space reservation notification process.

### DETAILED DESCRIPTION OF EMBODIMENTS

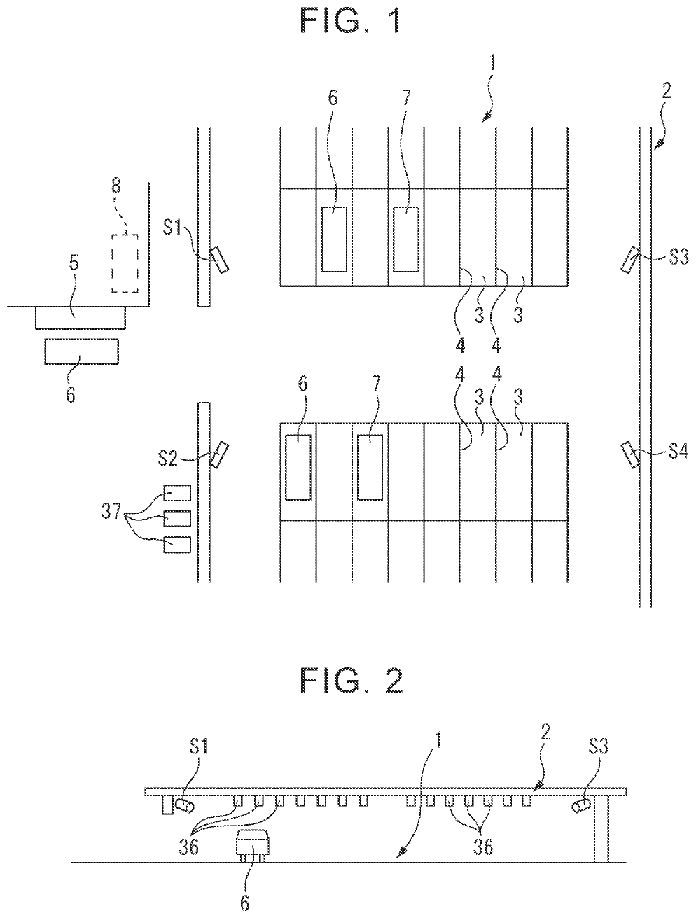

FIG. 1 is a plan view illustrating only a part of an automatic parking lot, and FIG. 2 is a side view of the automatic parking lot shown in FIG. 1. Referring to FIGS. 1 and 2, the reference sign 1 indicates a parking lot, the reference sign 2 indicates an automatic parking lot building, the reference sign 3 indicates a parking space, the reference sign 4 indicates a parking line indicating the outer edge of each parking space 3, the reference sign 5 indicates a pickup and drop-off area, the reference sign 6 indicates an autonomous vehicle, and the reference sign 7 indicates a manually driven vehicle. This parking lot 1 provides an automatic parking service, namely an automated valet parking service. The automatic parking service is a service in which an autonomous vehicle 6 that has reached the pickup and drop-off area 5 for drop-off is moved to and parked in an empty parking space 3 by autonomous driving, and an autonomous vehicle 6 parked in a parking space 3 is moved to the pickup and drop-off area 5 for pickup by autonomous driving. In FIG. 1, the reference sign 8 indicates a pickup and drop-off management server. The pickup and drop-off management server 8 is installed in a parking management facility, and manages pickups and drop-offs of vehicles. As shown in FIG. 1, manually driven vehicles 7 can also be parked in this automatic parking lot.

A large number of infrastructure sensors are usually installed in the automatic parking lot in order to detect the vehicle parking condition in the parking lot 1 or to set a travel route for a vehicle. As described above, FIGS. 1 and 2 illustrate an area in the automatic parking lot. In the example shown in FIGS. 1 and 2, four infrastructure sensors S1, S2, S3, and S4 are installed in order to detect the state of this area in the automatic parking lot. The infrastructure sensors S1, S2, S3, and S4 are, for example, cameras or laser sensors. For example, when the infrastructure sensors S1, S2, S3, and S4 are cameras, image signals captured by the infrastructure sensors S1, S2, S3, and S4 are sent to the pickup and drop-off management server 8.

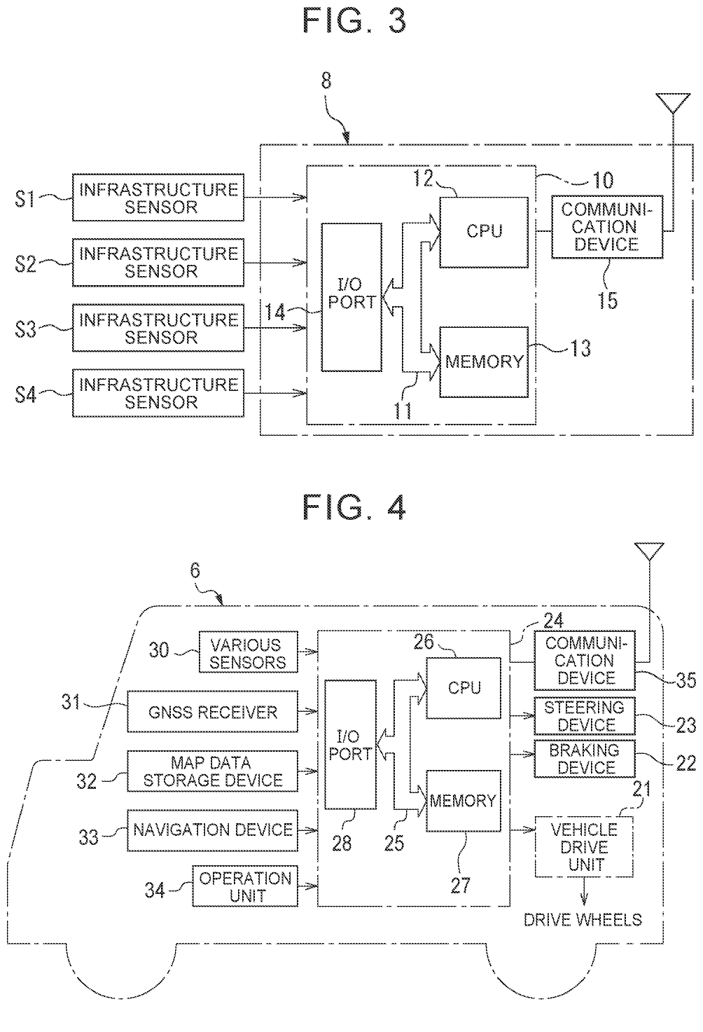

FIG. 3 shows the pickup and drop-off management server 8 in FIG. 1. As shown in FIG. 3, the pickup and drop-off management server 8 includes an electronic control unit 10. The electronic control unit 10 is a digital computer, and includes a central processing unit (CPU) (microprocessor) 12, a memory 13 composed of a read-only memory (ROM) and a random access memory (RAM), and an input/output port 14. The CPU 12, the memory 13, and the input/output port 14 are connected to each other by a bidirectional bus 11. As shown in FIG. 3, the image signals captured by the infrastructure sensors S1, S2, S3, and S4 are input to the electronic control unit 10. The memory 13 of the electronic control unit 10 stores map data of the parking lot 1.

FIG. 4 illustrates an example of an autonomous vehicle 6. Referring to FIG. 4, the reference sign 21 indicates a vehicle drive unit for applying a driving force to drive wheels of the autonomous vehicle 6, the reference sign 22 indicates a braking device for braking the autonomous vehicle 6, the reference sign 23 indicates a steering device for steering the autonomous vehicle 6, and the reference sign 24 indicates an electronic control unit mounted on the autonomous vehicle 6. As shown in FIG. 4, the electronic control unit 24 is a digital computer, and includes a CPU (microprocessor) 26, a memory 27 composed of a ROM and a RAM, and an input/output port 28. The CPU 26, the memory 27, and the input/output port 28 are connected to each other by a bidirectional bus 25. Various sensors 30 necessary for the autonomous vehicle 6 to perform autonomous driving, that is, sensors for detecting the state of the autonomous vehicle 6 and surroundings sensors for detecting the surroundings of the autonomous vehicle 6, are mounted on the autonomous vehicle 6. In this case, the sensors for detecting the state of the autonomous vehicle 6 are an acceleration sensor, a speed sensor, and an azimuth sensor, and the surroundings sensors for detecting the surroundings of the autonomous vehicle 6 are, for example, in-vehicle cameras, light detection and ranging (LIDAR) sensors, or radars for capturing images of the areas ahead of, to the side of, and behind the autonomous vehicle 6.

The autonomous vehicle 6 is provided with a Global Navigation Satellite System (GNSS) receiver 31, a map data storage device 32, a navigation device 33, and an operation unit 34 for performing various operations. The GNSS receiver 31 can detect the current position of the autonomous vehicle 6 (e.g., the latitude and longitude of the autonomous vehicle 6) based on information obtained from a plurality of artificial satellites. The current position of the autonomous vehicle 6 can therefore be acquired by the GNSS receiver 31. The GNSS receiver 31 is, for example, a Global Positioning System (GPS) receiver. The map data storage device 32 stores map data etc. necessary for the autonomous vehicle 6 to perform autonomous driving. The various sensors 30, the GNSS receiver 31, the map data storage device 32, the navigation device 33, and the operation unit 34 are connected to the electronic control unit 24. The autonomous vehicle 6 is equipped with a communication device 35 for communicating with the pickup and drop-off management server 8. As shown in FIG. 3, the pickup and drop-off management server 8 includes a communication device 15 for communicating with the autonomous vehicle 6.

In the example shown in FIG. 4, the vehicle drive unit 21 is an electric motor that is driven by a secondary battery or an electric motor that is driven by a fuel cell, and the drive wheels are driven and controlled by the electric motor according to an output signal from the electronic control unit 24. The braking device 22 performs braking control for the autonomous vehicle 6 according to an output signal from the electronic control unit 24, and the steering device 23 performs steering control for the autonomous vehicle 6 according to an output signal from the electronic control unit 24.

When a user who uses the automatic parking service parks his or her vehicle (autonomous vehicle) in the parking lot 1, the user sends a drop-off request together with a vehicle identification (ID) identifying his or her vehicle from, for example, his or her mobile terminal to the pickup and drop-off management server 8 via a communication network when, for example, his or her vehicle reaches the pickup and drop-off area 5. In response to the drop-off request, the pickup and drop-off management server 8 sets a travel route for the vehicle that allows the vehicle to move from the pickup and drop-off area 5 to an empty parking space 3 without coming into contact with other vehicles and pedestrians, and sends the set travel route to the user's vehicle. In this case, when a reservation of a desired parking space 3 has been made in advance for the vehicle, the pickup and drop-off management server 8 sets a travel route from the pickup and drop-off area 5 to the reserved parking space 3 for the vehicle. When no reservation of a parking space 3 has been made for the vehicle, the pickup and drop-off management server 8 sets a travel route from the pickup and drop-off area 5 to a selected empty parking space 3 for the vehicle. When the user's vehicle receives the set travel route from the pickup and drop-off management server 8, the user's vehicle is moved from the pickup and drop-off area 5 to the reserved parking space 3 or the selected empty parking space 3 along the set travel route by autonomous driving.

The same applies when the user picks up his or her vehicle from the parking lot 1. For example, when the user reaches the pickup and drop-off area 5, the user sends a pickup request together with the vehicle ID identifying his or her vehicle from his or her mobile terminal to the pickup and drop-off management server 8 via the communication network. In response to the pickup request, the pickup and drop-off management server 8 sets a travel route for the vehicle that allows the vehicle to move from the parking space 3 where the vehicle is currently parked to the pickup and drop-off area 5 without coming into contact with other vehicles and pedestrians, and sends the set travel route to the user's vehicle. When the user's vehicle receives the set travel route from the pickup and drop-off management server 8, the user's vehicle is moved from the parking space 3 where the vehicle is currently parked to the pickup and drop-off area 5 along the set travel route by autonomous driving.

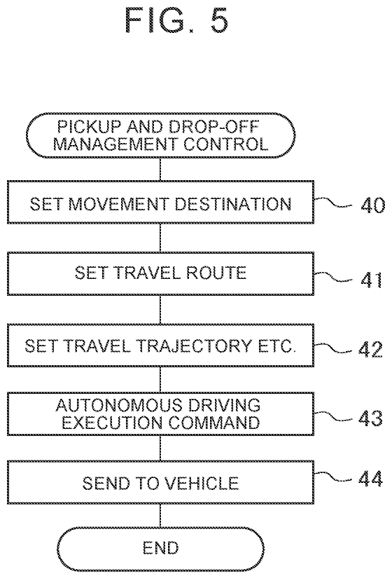

FIG. 5 shows a pickup and drop-off management control routine that is executed by the electronic control unit 10 when the pickup and drop-off management server 8 receives a drop-off request or a pickup request from an autonomous vehicle 6. Referring to FIG. 5, when the pickup and drop-off management server 8 receives a drop-off request from an autonomous vehicle 6, the electronic control unit 10 first sets the movement destination of the autonomous vehicle 6 in step 40. Specifically, when a reservation of a parking space 3 has been made in advance for the autonomous vehicle 6, the electronic control unit 10 sets the movement destination of the autonomous vehicle 6 to the reserved parking space 3 in step 40. When no reservation of a parking space 3 has been made for the autonomous vehicle 6, the electronic control unit 10 sets the movement destination of the autonomous vehicle 6 to a selected empty parking space 3 in step 40. Once the movement destination is set, the routine proceeds to step 41, and the electronic control unit 10 sets a travel route from the pickup and drop-off area 5 to the movement destination based on the map data of the parking lot 1 stored in the memory 13. Next, in step 42, the electronic control unit 10 determines such a travel trajectory and travel speed of the autonomous vehicle 6 that the autonomous vehicle 6 will not come into contact with other vehicles and structures. Thereafter, the electronic control unit 10 issues an autonomous driving execution command for the autonomous vehicle 6 in step 43, and the pickup and drop-off management server 8 then sends the set movement destination, travel route, travel trajectory, and travel speed and the autonomous driving execution command to the autonomous vehicle 6 in step 44.

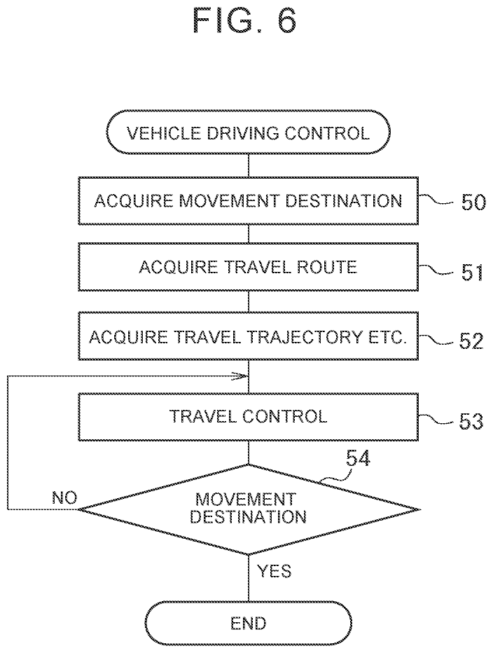

When the autonomous driving execution command is sent from the pickup and drop-off management server 8 to the autonomous vehicle 6, autonomous driving control for the autonomous vehicle 6 is started. FIG. 6 shows a vehicle driving control routine for performing the autonomous driving control for the autonomous vehicle 6. The electronic control unit 24 mounted on the autonomous vehicle 6 repeatedly executes this routine.

Referring to FIG. 6, the electronic control unit 24 first acquires the movement destination set by the pickup and drop-off management server 8 in step 50. The electronic control unit 24 then acquires the travel route set by the pickup and drop-off management server 8 in step 51, and acquires the travel trajectory and travel speed set by the pickup and drop-off management server 8 in step 52. In step 53, the electronic control unit 24 then performs travel control for the autonomous vehicle 6 along the set travel trajectory so that the autonomous vehicle 6 does not come into contact with other vehicles and pedestrians, based on the detection results from the surroundings sensors such as cameras, LIDAR sensors, or radars for capturing images of the areas around the autonomous vehicle 6 such as the area ahead of the autonomous vehicle 6. Thereafter, the electronic control unit 24 determines in step 54 whether the autonomous vehicle 6 has reached the movement destination. When the electronic control unit 24 determines that the autonomous vehicle 6 has not reached the movement destination, the routine returns to step 53, and the electronic control unit 24 continues the autonomous driving of the autonomous vehicle 6. On the other hand, when the electronic control unit 24 determines in step 54 that the autonomous vehicle 6 has reached the movement destination, that is, when the parking operation of the autonomous vehicle 6 is completed, the drop-off management ends.

When the user desires to pick up the autonomous vehicle 6, pickup and drop-off management control is also performed using the pickup and drop-off management control routine shown in FIG. 5. In this case, the electronic control unit 10 sets the movement destination of the autonomous vehicle 6 to the pickup and drop-off area 5 in step 40 of FIG. 5, sets a travel route from the parking space 3 where the autonomous vehicle 6 is currently parked to the pickup and drop-off area 5 in step 41, sets such a travel trajectory and travel speed of the autonomous vehicle 6 that the autonomous vehicle 6 will not come into contact with other vehicles and structures in step 42, and issues an autonomous driving execution command for the autonomous vehicle 6 in step 43. The pickup and drop-off management server 8 then sends the set movement destination, travel route, travel trajectory, and travel speed and the autonomous driving execution command to the autonomous vehicle 6 in step 44. When the autonomous vehicle 6 receives the set movement destination, travel route, travel trajectory, and travel speed and the autonomous driving execution command, a pickup process for the autonomous vehicle 6 is performed according to the driving control routine for the autonomous vehicle 6 shown in FIG. 6.

When picking up the vehicle (autonomous vehicle) from the parking lot 1, the time it takes for the vehicle to move from the parking space 3 to the pickup and drop-off area 5 by autonomous vehicle, namely the time required for pickup, is shorter when the vehicle is parked in a parking space 3 near the pickup and drop-off area 5 than when the vehicle is parked in a parking space 3 far from the pickup and drop-off area 5. It is therefore considered that users who use the automatic parking service often desire a parking space 3 near the pickup and drop-off area 5 as a parking space 3 for their vehicle when parking their vehicle in the parking lot 1.

The present disclosure is also applicable to an automatic parking system in which, when parking an autonomous vehicle 6 in the parking lot 1, the autonomous vehicle 6 is autonomously driven to a parking space 3 with an occupant(s) on board and the occupant(s) gets out of the autonomous vehicle 6 at the parking space 3, regardless of whether there is the pickup and drop-off area 5. In this case, it is considered that the occupant(s) of the autonomous vehicle 6 often desires a parking space 3 near the destination of the occupant(s)' visit as the parking space 3.

However, even if the user who uses the automatic parking service reserves a desired parking space 3 when making a reservation to drop off his or her vehicle (autonomous vehicle) at the parking lot 1, the user will not be able to use the desired parking space 3 if a manually driven vehicle 7 is stopped in the desired parking space 3. Therefore, in an embodiment of the present disclosure, when a reservation for a desired parking space 3 is made for an autonomous vehicle 6, each manually driven vehicle 7 in the parking lot 1 is notified of the reserved parking space 3.

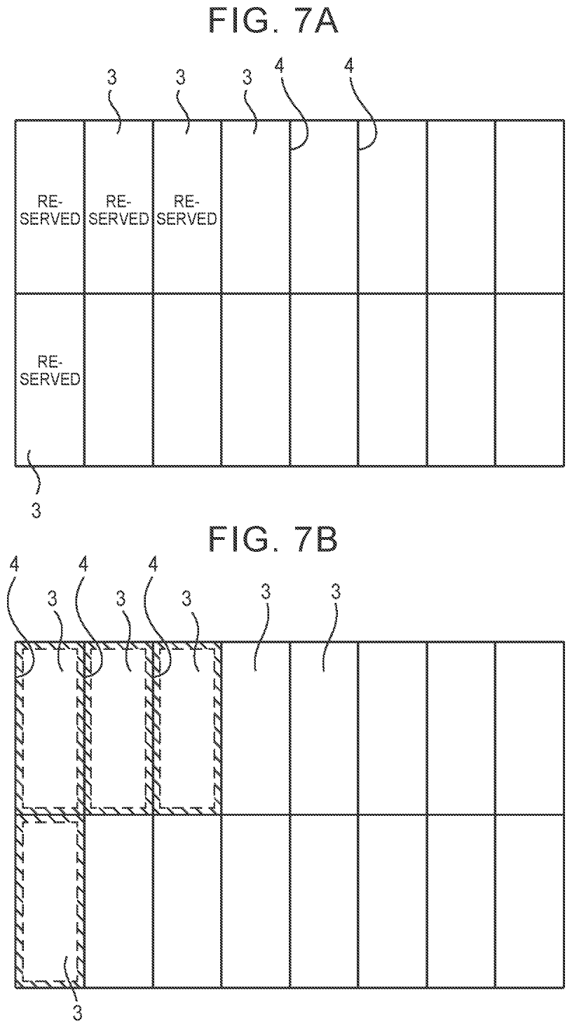

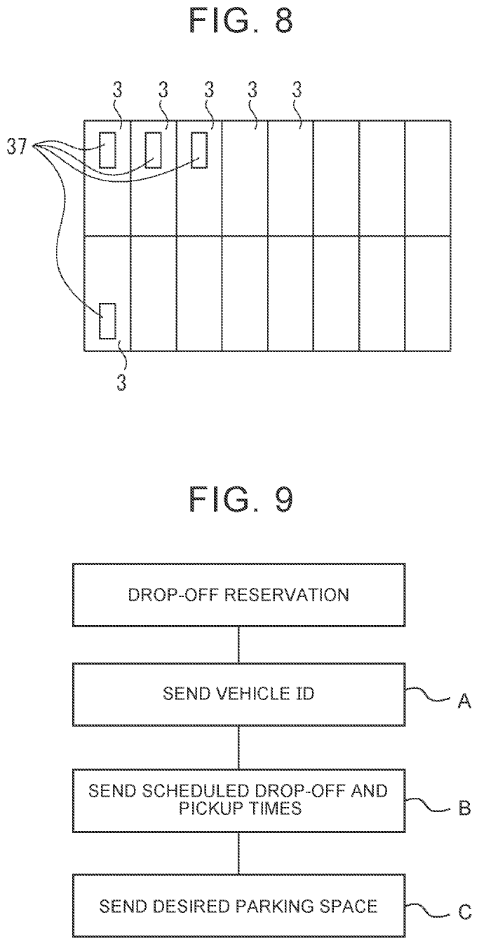

Next, some methods for notifying a manually driven vehicle 7 in the parking lot 1 of each reserved parking space 3 will be sequentially described with reference to FIGS. 7A to 8. In the example shown in FIG. 7A, a “reserved” indication is provided on each reserved parking space 3 in order to allow visual recognition that the parking space 3 is reserved. For example, as shown in FIG. 2, a large number of irradiators 36 are installed on the ceiling of the parking lot building 2 so as to correspond to the parking spaces 3, and a “reserved” indication is provided on the floor surface of each reserved parking space 3 by light emitted from the corresponding irradiator 36.

In the example shown in FIG. 7B, a red indication, for example, is provided on the outline area of each reserved parking space 3, namely the area between a dashed line and the parking lines 4 of each reserved parking space 3. In this case as well, for example, a red parking line indication indicating that the parking space 3 is reserved is provided on the floor surface of each reserved parking space 3 by light emitted from such an irradiator 36 as shown in FIG. 2.

In the example shown in FIG. 8, a moving body 37 indicating that the parking space 3 is reserved is stopped on each reserved parking space 3. The moving body 37 is, for example, a small manually driven four-wheeled vehicle or a small manually driven three-wheeled vehicle. The moving body 37 has a configuration similar to that of the autonomous vehicle 6 shown in FIG. 4, and has functions similar to those of the autonomous vehicle 6 shown in FIG. 4. The moving body 37 usually stands by at a stand-by area in the parking lot 1 as shown in FIG. 1, and as necessary, is moved from the stand-by area to the reserved parking space 3 by autonomous driving according to a travel command from the pickup and drop-off management server 8.

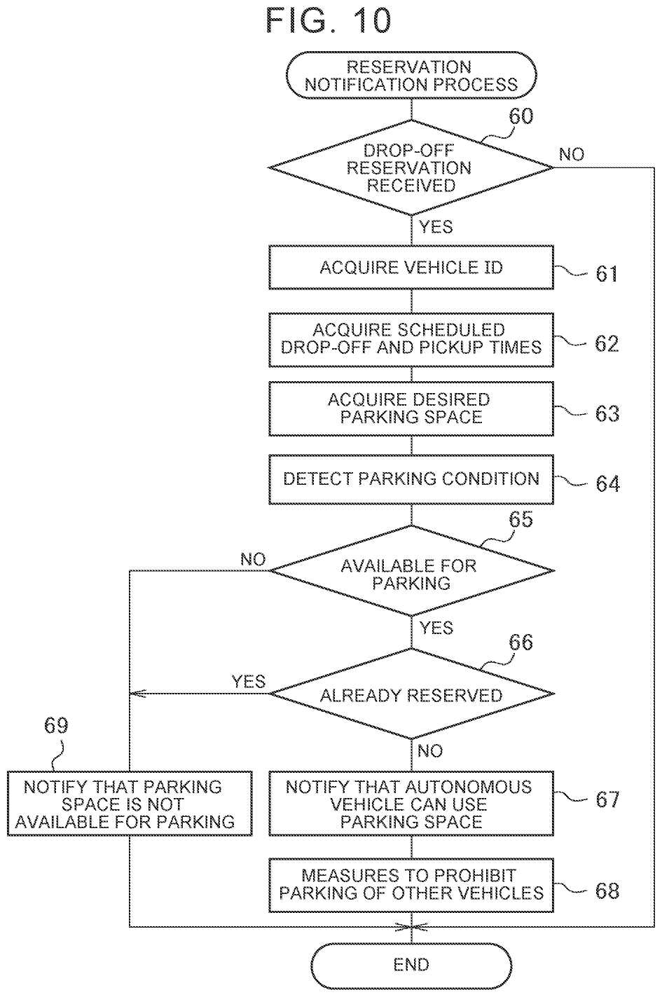

Next, a method for carrying out the embodiment according to the present disclosure will be described with reference to FIGS. 9 and 10. FIG. 9 shows a drop-off reservation process for the parking lot 1 that is performed by a user who uses the automatic parking service. In the embodiment according to the present disclosure, a drop-off reservation for the parking lot 1 is made by sending various kinds of information from the autonomous vehicle 6 or the user's mobile terminal to the pickup and drop-off management server 8 via the communication network. In the example shown in FIG. 9, the vehicle ID identifying the autonomous vehicle 6 to be dropped off as shown in A, the scheduled drop-off and pickup times as shown in B, and the desired parking space 3 as shown in C are sent to the pickup and drop-off management server 8.

FIG. 10 shows a reservation notification process routine for notifying that the parking space 3 is reserved. The electronic control unit 10 of the pickup and drop-off management server 8 repeatedly executes this routine.

Referring to FIG. 10, the electronic control unit 10 first determines in step 60 whether a drop-off reservation has been received. When the electronic control unit 10 determines that no drop-off reservation has been received, the processing cycle ends. On the other hand, when the electronic control unit 10 determines that a drop-off reservation has been received, the routine proceeds to step 61. The electronic control unit 10 acquires the vehicle ID of the autonomous vehicle 6 to be dropped off in step 61, acquires the scheduled drop-off and pickup times in step 62, and acquires the desired parking space 3 in step 63.

In step 64, the electronic control unit 10 then detects the parking condition in each parking space 3 in the parking lot 1 based on the image signals captured by the infrastructure sensors S1, S2, S3, and S4 and the map data of the parking lot 1 stored in the memory 13 of the electronic control unit 10. Thereafter, the electronic control unit 10 determines in step 65 whether another vehicle is already parked in the desired parking space 3, that is, whether the desired parking space 3 is available for parking, based on the detected parking condition. When another vehicle is already parked in the desired parking space 3, the electronic control unit 10 determines that the desired parking space 3 is not available for parking, and the routine proceeds to step 69. In step 69, the electronic control unit 10 sends a notification that the desired parking space 3 is not available for parking to the autonomous vehicle 6 or the user's mobile terminal.

On the other hand, when the electronic control unit 10 determines in step 65 that no other vehicle is parked in the desired parking space 3 and therefore the desired parking space 3 is available for parking, the routine proceeds to step 66. In step 66, the electronic control unit 10 determines whether the desired parking space 3 is already reserved by another user. When the electronic control unit 10 determines that the desired parking space 3 is already reserved by another user, the routine proceeds to step 69. In step 69, the electronic control unit 10 sends a notification that the desired parking space 3 is not available for parking to the autonomous vehicle 6 or the user's mobile terminal. On the other hand, when the electronic control unit 10 determines that the desired parking space 3 is not reserved by another user, the routine proceeds to step 67. In step 67, the electronic control unit 10 reserves the desired parking space 3 for the autonomous vehicle 6, and sends a notification that the autonomous vehicle 6 can use the desired parking space 3 to the autonomous vehicle 6 or the user's mobile terminal.

When the desired parking space 3 is reserved for the autonomous vehicle 6, the routine proceeds to step 68, and the electronic control unit 10 takes parking prohibition measures to prohibit parking of other vehicles in the desired parking space 3. When the desired parking space 3 is reserved, parking of other autonomous vehicles 6 in the desired parking space 3 is prohibited by steps 66, 69. Therefore, it is manually driven vehicles 7 that are prohibited from parking in the desired parking space 3 by the parking prohibition measures. Accordingly, in the embodiment according to the present disclosure, when a desired parking space 3 is reserved for an autonomous vehicle 6, each manually driven vehicle 7 in the parking lot 1 is notified of the reserved parking space 3.

In this case, in the embodiment according to the present disclosure, the parking prohibition measures are to provide visual recognition that the parking space 3 is reserved. That is, in step 68, the corresponding irradiator 36 is operated to provide a “reserved” indication on the floor surface of the reserved parking space 3 as shown in FIG. 7A or to provide on the floor surface of the reserved parking space 3 a red parking line indication indicating that the parking space 3 is reserved as shown in FIG. 7B. Alternatively, the moving body 37 standing by at the stand-by area in the parking lot 1 is moved from the stand-by area to the reserved parking space 3 by autonomous driving, and is stopped in the reserved parking space 3 as shown in FIG. 8.

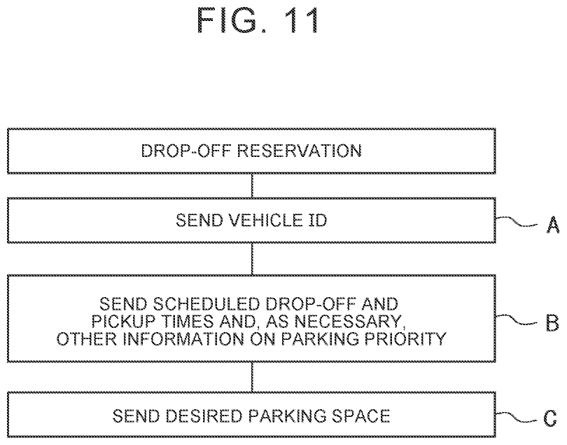

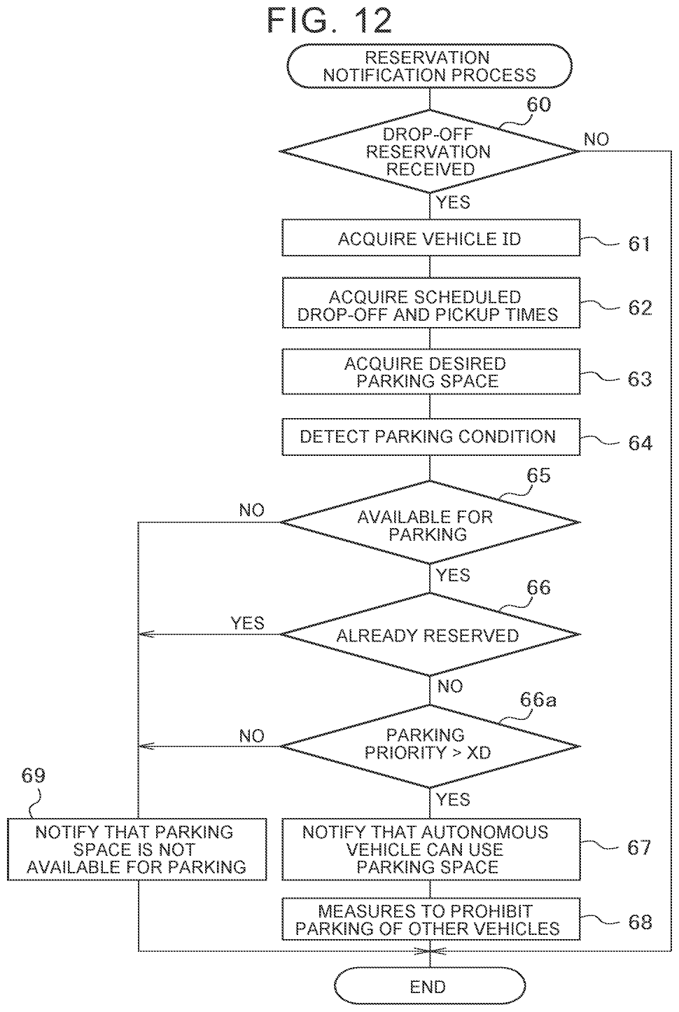

FIGS. 11 and 12 show a modification of the embodiment shown in FIGS. 9 and 10. In this modification, an index called parking priority is introduced for the use of a desired parking space 3. When an autonomous vehicle 6 has high parking priority, the autonomous vehicle 6 is allowed to have priority use of the desired parking space 3. The parking priority is determined according to, for example, the parking time and the remaining capacity of a battery. For example, the longer the parking time, the higher the parking lot usage fee that can be collected from the user. Therefore, the longer the parking time, the higher the parking priority. In the case where a power supply device is installed in the parking space 3 and the battery is to be charged while parking, the lower the remaining capacity of the battery, the higher the need for charging. Accordingly, in this case, the lower the remaining capacity of the battery, the higher the parking priority.

In this modification, information on the parking priority is sent to the pickup and drop-off management server 8 when making a drop-off reservation. In this case, the parking time is calculated from the scheduled drop-off and pickup times that are sent to the pickup and drop-off management server 8 when making a drop-off reservation. When it is desired to charge the battery while parking, a request to use the power supply device and information on the parking priority that is composed of the remaining capacity of the battery are sent to the pickup and drop-off management server 8 when making a drop-off reservation.

FIG. 11 shows a drop-off reservation process used in this modification. A and C in the drop-off reservation process of FIG. 11 are the same as A and C in the drop-off reservation process of FIG. 9, and only B in the drop-off reservation process of FIG. 11 is different from B in the drop-off reservation process of FIG. 9. Referring to FIG. 11, in this drop-off reservation process as well, the vehicle ID of the autonomous vehicle 6 to be dropped off and the desired parking space 3 are sent to the pickup and drop-off management server 8 as shown in A and C. In the drop-off reservation process of FIG. 11, however, as shown in B, other information on the parking priority is sent to the pickup and drop-off management server 8 as necessary in addition to the scheduled drop-off and pickup times.

FIG. 12 shows a reservation notification process routine for carrying out this modification. The electronic control unit 10 of the pickup and drop-off management server 8 repeatedly executes this routine.

Steps 60 to 69 of the reservation notification process routine shown in FIG. 12 are the same as steps 60 to 69 of the reservation notification process routine shown in FIG. 10. The only difference between the reservation notification process routine shown in FIG. 12 and the reservation notification process routine shown in FIG. 10 is that the reservation notification process routine shown in FIG. 12 includes an additional step 66a. Therefore, only the description related to the additional step 66a will be given regarding the reservation notification process routine shown in FIG. 12.

Referring to FIG. 12, when the electronic control unit 10 determines in step 65 that no other vehicle is parked in the desired parking space 3 and therefore the desired parking space 3 is available for parking, and determines in step 66 that the desired parking space 3 is not reserved by another user, the routine proceeds to step 66a. In step 66a, the electronic control unit 10 determines whether the parking priority is higher than set parking priority XD that is set in advance. For example, the electronic control unit 10 determines whether the parking time is longer than set parking time that is set in advance or whether the remaining capacity of the battery is lower than a set remaining capacity that is set in advance.

When the electronic control unit 10 determines in step 66a that the parking priority is higher than the set parking priority XD, such as when the electronic control unit 10 determines that the parking time is longer than the set parking time or when the electronic control unit 10 determines that the remaining capacity of the battery is lower than the set remaining capacity, the routine proceeds to step 67, and the electronic control unit 10 reserves the desired parking space 3 for the autonomous vehicle 6. In step 68, the electronic control unit 10 takes the parking prohibition measures to prohibit parking of other vehicles in the desired parking space 3. On the other hand, when the electronic control unit 10 determines in step 66a that the parking priority is lower than the set parking priority XD, such as when the electronic control unit 10 determines that the parking time is shorter than the set parking time or when the electronic control unit 10 determines that the remaining capacity of the battery is higher than the set remaining capacity, the routine proceeds to step 69, and the electronic control unit 10 sends a notification that the desired parking space 3 is not available for parking to the autonomous vehicle 6 or the user's mobile terminal.

As described above, in an embodiment according to the present disclosure, a parking lot management system for managing the parking lot 1 intended for automatic driving vehicles 6 and manually driven vehicles 7 includes: a reservation unit configured to reserve a parking space 3 for an autonomous vehicle 6; and a reserved parking space notification unit configured to notify a manually driven vehicle 7 in the parking lot 1 of the reserved parking space 3. In this case, the electronic control unit 10 of the pickup and drop-off management server 8 forms the reservation unit and the reserved parking space notification unit.

In an embodiment according to the present disclosure, a parking lot management method for managing the parking lot 1 intended for autonomous vehicles 6 and manually driven vehicles 7 is provided. The parking lot management method includes: reserving a parking space 3 for an autonomous vehicle 6; and notifying a manually driven vehicle 7 in the parking lot 1 of the reserved parking space 3. In an embodiment according to the present disclosure, a program for managing the parking lot 1 intended for autonomous vehicle 6 and manually driven vehicles 7 is provided. The program causes a computer to perform functions including: reserving a parking space 3 for an autonomous vehicle 6; and notifying a manually driven vehicle 7 in the parking lot 1 of the reserved parking space 3. The program is stored in a storage medium.

In an embodiment according to the present disclosure, the reserved parking space notification unit provides visual recognition that the parking space 3 is reserved. In an embodiment according to the present disclosure, the reserved parking space notification unit provides an indication on the reserved parking space by light emitted from the irradiator 36, the indication being an indication that allows recognition that the parking space 3 is reserved. In an embodiment according to the present disclosure, the reserved parking space notification unit moves the moving body 37 indicating that the parking space 3 is reserved to the reserved parking space 3.

In an embodiment according to the present disclosure, when the reservation unit acquires information on the parking space 3 desired for the autonomous vehicle 6 from the user who uses the parking lot 1, the reservation unit reserves the desired parking space 3 for the user unless the desired parking space 3 is already reserved and a manually driven vehicle 7 is currently parked in the desired parking space 3. In an embodiment according to the present disclosure, when the reservation unit acquires information on parking priority in addition to the information on the desired parking space 3 from the user who uses the parking lot 1, the reservation unit reserves the desired parking space 3 for the user unless the desired parking space 3 is already reserved and a manually driven vehicle 7 is currently parked in the desired parking space and when the parking priority is higher than set parking priority.

What is claimed is:

1. A parking lot management system for managing a parking lot intended for autonomous vehicles and manually driven vehicles, the parking lot management system comprising: a reservation unit configured to reserve a parking space for an autonomous vehicle; and a reserved parking space notification unit configured to notify a manually driven vehicle in the parking lot of the reserved parking space.

2. The parking lot management system according to claim 1, wherein the reserved parking space notification unit provides visual recognition that the parking space is reserved.

3. The parking lot management system according to claim 2, wherein the reserved parking space notification unit provides an indication on the reserved parking space by light emitted from an irradiator, the indication being an indication that allows recognition that the parking space is reserved.

4. The parking lot management system according to claim 2, wherein the reserved parking space notification unit moves a moving body indicating that the parking space is reserved to the reserved parking space.

5. The parking lot management system according to claim 2, wherein when the reservation unit acquires information on the parking space desired for the autonomous vehicle from a user who uses the parking lot, the reservation unit reserves the desired parking space for the user unless the desired parking space is already reserved and a manually driven vehicle is currently parked in the desired parking space.

6. The parking lot management system according to claim 5, wherein when the reservation unit acquires information on parking priority in addition to the information on the desired parking space from the user who uses the parking lot, the reservation unit reserves the desired parking space for the user unless the desired parking space is already reserved and a manually driven vehicle is currently parked in the desired parking space and when the parking priority is higher than set parking priority.

7. A parking lot management method for managing a parking lot intended for autonomous vehicles and manually driven vehicles, the parking lot management method comprising: reserving a parking space for an autonomous vehicle; and notifying a manually driven vehicle in the parking lot of the reserved parking space.

8. A non-transitory storage medium storing a program for managing a parking lot intended for autonomous vehicle and manually driven vehicles, the program causing a computer to perform functions comprising: reserving a parking space for an autonomous vehicle; and notifying a manually driven vehicle in the parking lot of the reserved parking space.
